(19) United States
(12) Patent Application Publication
(10) Pub. No.: US 2006/0072983 A1
(43) Pub. Date: Apr. 6, 2006

(54) Device for pressing on a book casing

(75) Inventor: Hans Muller, Lauda-Konigshofen (DE)

Correspondence Address: VENABLE LLP, P.O. BOX 34385, WASHINGTON, DC, 20045-9998, US

(73) Assignee: Muller Martini Holding AG, Hergiswil (CH)

(21) Appl. No.: 11/236,860

(22) Filed: Sep. 28, 2005

(30) Foreign Application Priority Data
Oct. 2, 2004 (DE) 20 2004 015 354.8

(51) Int. Cl. B42C 13/00

(52) U.S. Cl. 412/22

(57) ABSTRACT

A device for pressing a book casing onto adhesive-coated outer surfaces of a book block includes a circulating conveyor having a perpendicular section and saddle plates arranged to be conveyed upward in the perpendicular section. A press on device, with a press-on region and operating synchronously with the circulating conveyor, includes press-on rollers arranged opposite each other in the press-on region. The rollers respectively press one cover of the casing onto one adhesive-coated outer surface of a book block which is positioned straddling on one of the saddle plates conveyed upward in the perpendicular section of the circulating conveyor. A support plane is provided so that a book casing can be positioned and evenly spread out to match a length of the book block conveyed on the saddle plate. The support plane is arranged so that the book casing thereon can be supplied transversely to the perpendicular conveying section to a holding position for takeover by the book block. A flexible hold-down device is located above the holding position to press the evenly spread out book casing onto the support plane.

### CROSS-REFERENCE TO RELATED APPLICATION

This application claims the priority of German Utility Patent No. 202004 015 354.8, filed on Oct. 2, 2004. The subject matter of the foregoing application and that of each U.S. and foreign patent and patent application mentioned below, is incorporated herein by reference.

### BACKGROUND OF THE INVENTION

The invention relates to a device for pressing a book casing onto adhesive-coated outer surfaces of a book block to be provided with a book casing inside a book-block casing-in machine. The device comprises two press-on rollers, arranged opposite each other in a press-on region, which respectively press one cover of the book casing against one adhesive-coated outer surface of a book block which is positioned straddling a support plate and is conveyed upward in a vertical section of a circulating conveyor, wherein these press-on rollers belong to a press-on device that operates synchronously with the conveyor. For the takeover by the book block, the book casing is fed to a holding position while lying flat on a sliding plane and aligned transverse to the perpendicular conveying section and is spread out so that it coincides with the length of the book block conveyed on the saddle plate.

With respect to improving the quality of a book and to increase the production reliability during the takeover and/or fitting of a book casing onto the supplied book block, a simple device is required which is installed on the book block casing-in machine and operates jointly with the press-on device.

The danger with book block casing-in machines as disclosed in German patent document DE 20 16 425 C or European patent document EP 1 072 436 A1 is that an aligned and ready book casing is lifted up in an uncontrolled manner by an upward moving book block and, in the process, is displaced before the press-on rollers of the press-on device can secure the position of the book casing on the book block spine. This problem is caused by the fact that before the book block takes over the book casing, the press-on device must be accelerated to the speed of the book block, thus causing it to be lifted slightly off the ready book casing.

### SUMMARY OF THE INVENTION

It is an object of the present invention to correct this problem by creating a device of the aforementioned type which does not pose high requirements with respect to technical design and costs.

The above and other objects are accomplished according to an embodiment of the invention by the provision of a device for pressing a book casing onto adhesive-coated outer surfaces of a book block to be fitted with a book casing inside a book block casing-in machine, comprising: a circulating conveyor having a perpendicular section and saddle plates arranged to be conveyed upward in the perpendicular section; a press on device having a press-on region and operating synchronously with the circulating conveyor, the press on device including press-on rollers arranged opposite each other in the press-on region, which rollers respectively press one cover of the casing onto one adhesive-coated outer surface of a book block which is positioned straddling on one of the saddle plates conveyed upward in the perpendicular section of the circulating conveyor; a support plane on which a book casing can be positioned and evenly spread out to match a length of the book block conveyed on the saddle plate, the support plane being arranged so that the book casing thereon can be supplied transversely to the perpendicular conveying section to a holding position for takeover by the book block; and a flexible hold-down device located above the holding position to press the evenly spread out book casing onto the support plane.

Thus, according to the invention, a flexible hold-down device is installed above the holding position, which secures the book casing by pressing it onto the sliding plane. This increases both the production quality and the book quality. The hold-down device furthermore results in clamping in the book casing during the takeover by the book block, so that the back of the book casing can be fitted precisely onto the spine of the book block which is positioned straddling on a saddle plate, thereby causing the book casing to fit tightly against the book block.

The hold-down device advantageously requires only a simple installation on the press-on device.

It is furthermore advantageous if the hold-down device is provided with a hold-down element which acts upon a book cover by securing it precisely in the required position.

The hold-down element is preferably flexible and/or elastically deformable in the conveying direction of the book block, so that the hold-down element can be compressed easily. The hold-down device may comprise a material such as rubber, foam, or other material with similar properties. For example, a resilient metal spring element may be used as the hold-down device.

The hold-down element surface which faces a book cover is advantageously smooth, so that it leaves no permanent traces during the lifting up by means of the book block.

Also suitable may be a profiled surface for the hold-down element which has a reduced surface area as compared to a solid surface.

### BRIEF DESCRIPTION OF THE DRAWINGS

These and other features and advantages of the invention will be further understood from the following detailed description of the invention with reference to the accompanying drawings to which reference is made for all details not expressly mentioned in the text.

FIG. 1 is a cross section through the conveyor for a book block casing-in machine, showing the region of a press-on device, with the device in the starting position.

FIG. 2 is representation according to FIG. 1, showing the start of the press-on operation.

### DETAILED DESCRIPTION OF THE INVENTION

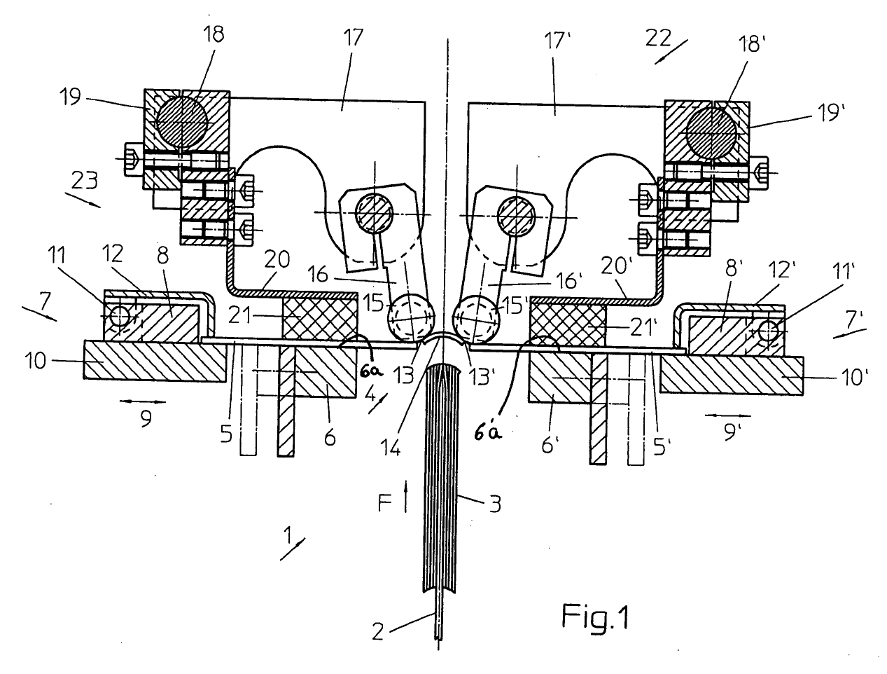

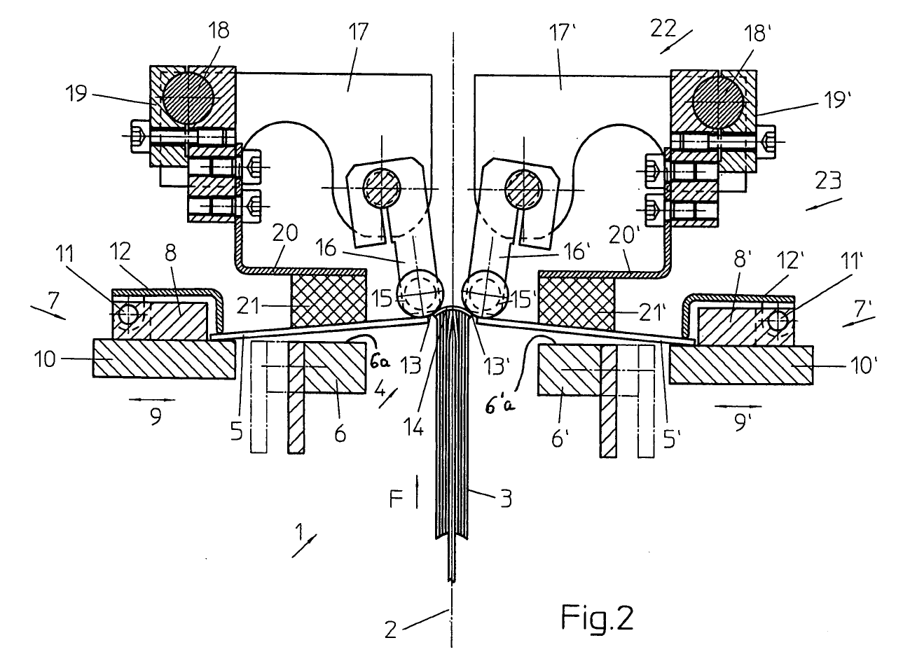

Referring to FIGS. 1 and 2, there is shown details of a vertical conveyor section 1, in the press-on region for a book block casing-in machine. See also European patent document EP 1 072 436 A1. FIG. 1 in this case shows the starting position for an upward-moving saddle plate 2 on the conveyor, immediately before the book block 3, which is suspended straddling on the saddle plate 2, makes contact with the inside of a book casing 4. Book casing 4 is supplied to the press-on region while positioned crosswise to the movement F direction for the saddle plate 2. The book casing 4 rests with the book covers 5, 5′ on a supporting and/or sliding plane or surface 6a, 6′a, formed by two support bars 6, 6′, respectively, and is guided on the side inside a guide arrangement, delimited by two guide elements 7, 7′, which function to supply and align the book casing 4. The guide elements 7, 7′ on the side can be adjusted to the different format sizes and thicknesses of a book casing 4. The support bars 6, 6′ for the sliding plane can also be adjusted to the format size of a book casing 4, as indicated with the dash-dot lines.

The guide elements 7, 7′ on the side are embodied in the form of guide bars 8, 8′ which rest on support bars 10, 10′ that can be adjusted as shown with double arrows 9, 9′. The support bars 8, 8′ comprise horizontally extending pivoting axes 11, 11′, arranged parallel to the saddle plate 2, on which respectively a yoke 12, 12′ is positioned pivoting, such that it can act upon the side edge region of a book cover 5, 5′ as a result of its own weight. The yoke 12, 12′ is embodied so that it can be adjusted with respect to its vertical position to adapt to a change in the book cover thickness. The book casing 4 is provided between the book covers 5, 5′ with a back insert 14, which is separated by joints 13, 13′ from the front and back cover and which forms the back of the finished book.

FIGS. 1 and 2 furthermore show two press-on rollers 15, 15′, positioned opposite each other in the conveying section 1 of the press-on region and such that they can rotate on the exposed ends of pivoting arms 16, 16′ , which act upon the outer surface of a book block and/or the book covers 5, 5′ during the press-on operation as a result of a generated force, for example of a spring force. The pivoting arms 16, 16′ are positioned on supports 17, 17′ which also move upward with the conveyor and/or the saddle plate 2 after reaching the synchronization phase. The two supports 17, 17′ are joined at the upper end (not visible herein). Separate crossbeams 18, 18′ are respectively attached to the supports 17, 17′ and are provided with detachable clamps 19, 19′. Screwed to each clamp 19, 19′ is an angular profile 20, 20′ for securing an elastically deformable element 21, 21′, wherein the element 21, 21′ can advantageously be connected by vulcanization to the angular profile 20, 20′. Soft rubber elements, rubber profiles, foam materials, or other materials with at least similar characteristics can be used for the elastically deformable element 21, 21′. The element 21, 21′ shown herein has a rectangular cross-sectional shape, but could also be rounded off and/or rounded at the surface facing the book covers 5, 5′. To create favorable sliding characteristics for the book covers 5, 5′, it is advantageous if the element 21, 21′ surface is smooth on the side facing a cover 5, 5′, so that little friction is generated when the casing 4 is fitted on because the element 21, 21′ is pressed onto the book cover 5, 5′. The position of the element 21, 21′ must be maintained, even with thicker book covers 5, 5′, meaning the elasticity of the element 21, 21′ compensates for the change in thickness of the book cover. A height adjustment by the angular profile 20, 20′ is therefore not absolutely necessary.

FIG. 2 shows the short synchronization phase during which the book block 3 is joined with the book casing 4 and both are subsequently transported jointly by the conveyor and the press-on device 22. In this phase, the book casing 4 is raised slightly from the resting position and the side ends of the book covers 5, 5′ are correspondingly pulled toward the inside. In the process, the book covers 5, 5′ are pulled through below the hold-down device 23 and are pressed by the press-on rollers 15, 15′ against the outer surfaces of the book block 3 which moves along.

It will be understood that the above description of the present invention is susceptible to various modifications, changes and adaptations, and the same are intended to be comprehended within the meaning and range of equivalents of the appended claims.

What is claimed is:

1. A device for pressing a book casing onto adhesive-coated outer surfaces of a book block to be fitted with a book casing inside a book block casing-in machine, comprising:
a circulating conveyor having a perpendicular section and saddle plates arranged to be conveyed upward in the perpendicular section;
a press on device having a press-on region and operating synchronously with the circulating conveyor, the press on device including press-on rollers arranged opposite each other in the press-on region, which rollers respectively press one cover of the casing onto one adhesive-coated outer surface of a book block which is positioned straddling on one of the saddle plates conveyed upward in the perpendicular section of the circulating conveyor;
a support plane on which a book casing can be positioned and evenly spread out to match a length of the book block conveyed on the saddle plate, the support plane being arranged so that the book casing thereon can be supplied transversely to the perpendicular conveying section to a holding position for takeover by the book block; and
a flexible hold-down device located above the holding position to press the evenly spread out book casing onto the support plane.

2. The device according to claim 1, wherein the hold-down device is attached to the press-on device.

3. The device according to claim 1, wherein the hold-down device comprises hold-down elements each acting on a respective one of the book covers of the book casing.

4. The device according to claim 3, wherein the hold-down elements each comprise an elastically deformable element.

5. The device according to claim 4, wherein the elastically deformable elements each comprise one of rubber, foam, or an element having similar resilient properties as rubber or foam.

6. The device according to claim 4, wherein the hold-down elements each have a surface facing the respective book cover that is smooth.

7. The device according to claim 4, wherein hold-down elements each have a surface facing the respective book cover that is profiled.

8. The device according to claim 1, wherein the hold-down device operates jointly with the support plane for the book casing.
